(19) United States
(12) Patent Application Publication
(10) Pub. No.: US 2026/0250557 A1
(43) Pub. Date: Aug. 27, 2026

(54) STABILIZED HOT MELT PRESSURE-SENSITIVE ADHESIVES

(71) Applicant: 3M INNOVATIVE PROPERTIES COMPANY, St. Paul, MN (US)

(72) Inventors: Ross E. Behling, Woodbury, MN (US); Thomas Q. Chastek, St. Paul, MN (US); Mark E. Napierala, St. Paul, MN (US); Patrick M. Crain, Stillwater, MN (US)

(21) Appl. No.: 18/994,373

(22) PCT Filed: Jul. 18, 2023
(86) PCT No.: PCT/IB2023/057343

§ 371 Date: Jan. 14, 2025

Related U.S. Application Data
(60) Provisional application No. 63/393,495, filed on Jul. 29, 2022.

(51) Int. Cl. C09J 7/35; C09J 11/06; C09J 11/08

(52) U.S. Cl. CPC C09J 7/35; C09J 11/06; C09J 11/08; C09J 2301/202; C09J 2301/302; C09J 2301/304; C09J 2301/408

(57) ABSTRACT

High-performance, hot melt pressure-sensitive adhesives (“hmPSAs”) including 40 weight percent (“wt. %”) to 60 wt. % of a block copolymer comprising polystyrene and polyisoprene, 30 wt. % to 60 wt. % of a first tackifying resin, 1 wt. % to 15 wt. % of a polyphenylene oxide tackifier; and 0.5 wt. % to 5 wt. % of a stabilizer represented by the Structure I: (I) where each of R¹, R², R³, and R⁴ is independently selected from the group consisting of a C1 to C5 alkyl group, an unsubstituted phenyl group, a substituted phenyl group, an unsubstituted benzyl group, a substituted benzyl group, and combinations thereof. Articles comprising the hmPSAs and methods of preparing the hmPSAs are provided.

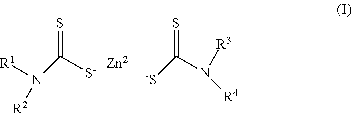

### BACKGROUND

Adhesives are used in a variety of marking, holding, protecting, sealing, and masking applications. One type of adhesive, a pressure-sensitive adhesive, is particularly preferred for many applications. Pressure-sensitive adhesives (“PSAs”) are well known to persons of ordinary skill in the relevant arts to possess certain properties at room temperature (e.g., 23° C.), including: (1) aggressive and permanent tack, (2) adherence with no more than finger pressure, (3) sufficient ability to hold onto an adherend, and (4) sufficient cohesive strength. Materials that have been found to function well as pressure-sensitive adhesives are polymers designed and formulated to exhibit the requisite viscoelastic properties resulting in a desired balance of tack, peel adhesion, and shear strength. Characteristics of PSAs are described, for example, in the Encyclopedia of Polymer Science and Engineering, Vol. 13, Wiley-Interscience Publishers (New York, 1988) and the Encyclopedia of Polymer Science and Technology, Vol. 1, Interscience Publishers (New York, 1964).

It is known that pressure-sensitive adhesives can be prepared by compounding an elastomer and a suitable tackifier. Elastomers useful in the preparation of PSAs include styrenic block copolymers, which comprise a polymerized glassy styrene block and a polymerized rubbery block (e.g., polyisoprene). Radial styrenic block copolymers are a subset of styrenic block copolymers where the elastomer has a multi-arm, rather than a linear structure. At ambient temperatures, the styrenic block and the rubbery block microphase separate into discrete but connected domains to provide an elastomeric structure that is thermally reversible. The addition of a tackifier such as, for example, a rosin ester, can convert a styrenic block copolymer from an elastic material into a viscoelastic material. A given tackifier can be compatible (i.e., miscible) with the glassy block, the rubbery block, or at least partially compatible with both types of blocks. Selective compatibility enables a given tackifier, when added to a styrenic block copolymer, to modify the properties of either the rubbery or glassy domains of the microphase separated structure.

### SUMMARY

Provided herein are adhesives including SIS block copolymers, PPO, and dialkyldithiocarbamates that are excellent PPO stabilizers and can dramatically reduce the oxidative degradation of PPO in SIS block copolymer adhesive formulations.

In one aspect provided are high-performance, hot melt pressure-sensitive adhesives (“hmPSAs”) including 40 weight percent (“wt. %”) to 60 wt. % of a block copolymer comprising polystyrene and polyisoprene, 30 wt. % to 60 wt. % of a first tackifying resin, 1 wt. % to 15 wt. % of a polyphenylene oxide tackifier; and 0.5 wt. % to 5 wt. % of a stabilizer represented by the Structure I:

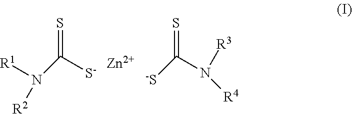

where each of R¹, R², R³, and R⁴ is independently selected from the group consisting of a C1 to C5 alkyl group, an unsubstituted phenyl group, a substituted phenyl group, an unsubstituted benzyl group, a substituted benzyl group, and combinations thereof.

In another aspect, a tape is provided, the tape comprising: a backing; and a pressure-sensitive adhesive layer disposed on the backing and comprised of the disclosed hmPSA composition.

In another aspect, a bonded assembly is provided, the bonded assembly comprising: a low surface energy substrate; and a pressure-sensitive adhesive layer disposed on the low surface energy substrate and comprised of the disclosed hmPSA composition.

In another aspect, methods of preparing stabilized hot melt pressure-sensitive adhesives are provided.

As used herein:
the term “ambient temperature” means at a temperature of 25° C.;
the term “compatible with” means miscible with or soluble with;
the term “substituted” used in conjunction with a molecule or an organic group refers to the state in which one or more hydrogen atoms contained therein are replaced by one or more non-hydrogen atoms;
the term “tackifier” may be used herein interchangeably with the term “tackifying resin” and refers to high glass transition, Tg, resins used as additives to increase adhesive Tg while simultaneously reducing storage modulus; and
the term “unsubstituted” used in conjunction with a molecule or an organic group refers to the state in which none of the hydrogen atoms contained therein are replaced by one or more non-hydrogen atoms.

Features and advantages of the present disclosure will be further understood upon consideration of the detailed description as well as the appended claims.

### BRIEF DESCRIPTION OF THE DRAWINGS

FIG. 1 is a perspective view of a ribbed plastic substrate for use with disclosed adhesive compositions.

FIGS. 2 and 3 are side elevational views of an adhesive-backed tapes including disclosed adhesive compositions.

FIG. 4 is a fragmentary side view of a bonded assembly in which a disclosed adhesive composition is used to adhere the substrate of FIG. 1 to a different substrate.

Repeated use of reference characters in the specification and drawings is intended to represent the same or analogous features or elements of the disclosure. Numerous other modifications and embodiments can be devised by those skilled in the art, which fall within the scope and spirit of the principles of the disclosure. Figures may not be drawn to scale.

### DETAILED DESCRIPTION

Reference will now be made to various embodiments of the disclosed subject matter. While the disclosed subject matter will be described in conjunction with the enumerated claims, it will be understood that the exemplified subject matter is not intended to limit the claims to the disclosed subject matter.

The terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for description only and not of limitation. Any use of section headings is intended to aid reading of the document and is not to be interpreted as limiting; information that is relevant to a section heading may occur within or outside of that section.

To meet the elevated temperature performance specifications of automotive and industrial manufacturers producing articles comprising styrene-isoprene-styrene (“SIS”) block copolymers, it may be advantageous to include polyphenylene oxide (“PPO”) as a high Tg material to reinforce the styrene domains of these SIS block copolymers. However, PPO is particularly susceptible to oxidative degradation at elevated temperatures. The resulting PPO oxidative degradation reactions can cause the isoprene midblock of the SIS base resin to degrade or depolymerize, thereby causing adhesives including the SIS base resin to lose some of their necessary performance characteristics, e.g., stretch release properties may be sensitive to this type of aging.

It has been surprisingly discovered that when added to adhesives including SIS block copolymers and PPO, certain dialkyldithiocarbamates are excellent PPO stabilizers and can dramatically reduce the oxidative degradation of SIS block copolymers in PPO-containing adhesive formulations, degradations that result in the loss of performance characteristics when the adhesive is exposed to heat and oxygen.

The present disclosure provides high-performance, hot melt pressure-sensitive adhesives (“hmPSAs”) including 40 weight percent (“wt. %”) to 60 wt. % of a block copolymer comprising polystyrene and polyisoprene, 30 wt. % to 60 wt. % of a first tackifying resin, 1 wt. % to 15 wt. % of a polyphenylene oxide tackifier; and 0.5 wt. % to 5 wt. % of a stabilizer represented by the Structure I:

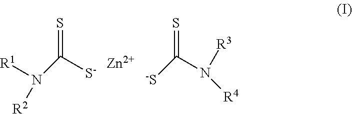

where each of R¹, R², R³, and R⁴ is independently selected from the group consisting of a C1 to C5 alkyl group, an unsubstituted phenyl group, a substituted phenyl group, an unsubstituted benzyl group, a substituted benzyl group, and combinations thereof.

### Block Copolymer

Block copolymers useful in embodiments of the present disclosure are known in the art. The block copolymer can be a single block copolymer or a mixture of two or more block copolymers. At least one block copolymer in the block copolymer component is a styrenic block copolymer including an isoprene rubbery block (or low-T_{g} block) and two or more styrene glassy blocks (or high-T_{g} blocks). In some embodiments the block copolymer component may further include at least a second styrenic block copolymer including an isoprene rubbery block (or low-T_{g} block) and two or more styrene glassy blocks (or high-T_{g} blocks), where such additional styrenic block copolymer may be a linear block copolymer or a star block copolymer as described below.

At the service temperature of the adhesive, the block copolymer component microphase separates into ordered nanoscale domains that include rubbery block domains and glassy block domains. This ordered structure provides the block copolymer component with useful and unique physical properties. When microphase separated, these copolymers form elastic, dimensionally stable solids that display significant shear strength. Unlike chemically crosslinked rubbers, these materials, also referred to herein as “hot-melt processible” adhesives, are capable of being reversibly melted and re-solidified with heat as little to no covalent crosslinking occurs throughout the lifetime of the adhesive. Typically, the upper service temperature of formulations without PPO is limited to 70° C. or lower, and therefore covalent cross linking is often employed to increase the service temperature. However, inclusion of PPO can raise the upper service temperature to 80° C. or even higher, while maintaining the thermoplastic nature, and allowing for reprocessing at elevated temperatures, generally above 150° C. The ability to reprocess allows for automated dispensing at a final manufacturing endpoint (e.g., the use of core-sheath filaments and dispensers) and also allows for reuse or recycling of materials. In contrast, covalently cross linked formulations are limited to tape formats with fixed/defined geometries.

The styrenic block copolymer may be a linear block copolymer of general formula (G-R)ₘ-G where G is a glassy block, R is a rubbery block, and m is an integer equal to or greater than 1. In some embodiments, the value of m can range from 1 to 10, 1 to 5, 1 to 3, or in some embodiments, less than, equal to, or greater than 1, 2, 3, 4, 5, 6, 7, 8, 9, or 10. In a preferred embodiment, the linear block copolymer is a triblock copolymer of formula G-R-G where the variable m in the formula (G-R)ₘ-G is equal to 1.

Alternatively, the styrenic block copolymer can be a star (also known as a radial or multi-arm) block copolymer of general formula (G-R)ₙ-Y where each R and G are the same as defined above, n is an integer equal to at least 3, and Y is the residue of a multifunctional coupling agent used in the formation of the star block copolymer. The variable n represents the number of arms in the star block copolymer and can range from 3 to 10, from 3 to 8, from 3 to 6, or in some embodiments, less than, equal to, or greater than 3, 4, 5, 6, 7, 8, 9, or 10.

In both the linear block copolymer and star block copolymer forms of the styrenic block copolymer, the glassy blocks can have the same or different molecular weight. Similarly, if there is more than one rubbery block, the rubbery blocks can have the same or different molecular weights.

Generally, each rubbery block has a glass transition temperature (T_{g}) that is less than ambient temperature. For example, the glass transition temperature can be less than 20° C., less than 0° C., less than −10° C., less than −20° C., less than −40° C., less than −60° C., or in some embodiments, less than, equal to, or greater than −60° C., −55, −50, −45, −40, −35, −30, −25, −20, −15, −10, −5, 0, 5, 10, 15, or 20° C. The glass transition temperature can be determined using conventional methods known in the art, including, for example, Differential Scanning calorimetry and/or Dynamic Mechanical Analysis.

Each rubbery block in the linear or star block copolymers is typically the polymerized product of a first polymerized conjugated diene, a hydrogenated derivative of a polymerized conjugated diene, or a combination thereof. The conjugated diene often contains 4 to 12 carbon atoms. Conjugated dienes may include, but are not limited to, butadiene, isoprene, 2-ethylbutadiene, 1-phenylbutadiene, 1,3-pentadiene, 1,3-hexadiene, 2,3-dimethyl-1,3-butadiene, and 3-ethyl-1,3-hexadiene.

Each rubbery block can be a homopolymer or copolymer. The rubbery block is often, for example, poly(butadiene), poly(isoprene), poly(2-ethylbutadiene), poly(1-phenylbutadiene), poly(1,3-pentadiene), poly(1,3-hexadiene), poly(2,3-dimethyl-1,3-butadiene), poly(3-ethyl-1,3-hexadiene), poly(ethylene/propylene), poly(ethylene/butylene), or poly(isoprene/butadiene). In many embodiments, the R block is polybutadiene, polyisoprene, poly(isoprene/butadiene), poly(ethylene/butylene), or poly(ethylene/propylene).

The glass transition temperature of each glassy block is generally at least 50° C., at least 60° C., at least 70° C., at least 80° C., at least 90° C., at least 100° C., at least 105° C. at least 110° C., or in some embodiments, less than, equal to, or greater than 50° C., 55, 60, 65, 70, 75, 80, 85, 90, 95, 100, 105, or 110° C.

Each glassy block in the linear or star block copolymers is typically the polymerized product of a mono-vinyl aromatic monomer. The mono-vinyl aromatic monomer usually contains, for example, at least 8 carbon atoms, at least 10 carbon atoms, or at least 12 carbon atoms and up to 18 carbon atoms, up to 16 carbon atoms, or up to 14 carbon atoms. Example mono-vinyl aromatic monomers include, but are not limited to, styrene, vinyl toluene, alpha-methyl styrene, 2,4-dimethyl styrene, ethyl styrene, 2,4-diethyl styrene, 3,5-diethyl styrene, alpha-2-methyl styrene, 4-tert-butyl styrene, and 4-isopropyl styrene.

Each glassy block can be a homopolymer or a copolymer. The glassy block can be poly(styrene), poly(vinyl toluene), poly(alpha-methyl styrene), poly(2,4-dimethyl styrene), poly(ethyl styrene), poly(2,4-diethyl styrene), poly(3,5-diethyl styrene), poly(alpha-2-methyl styrene), poly(4-tert-butyl styrene), poly(4-isopropyl styrene), and copolymers thereof.

In some embodiments, the glassy block is polystyrene homopolymer or is a copolymer derived from a mixture of styrene and a styrene-compatible monomer, i.e., a monomer that is miscible with styrene. In most cases where the glassy phase is a copolymer, at least 50 weight percent of the monomeric units are derived from styrene. For example, at least 60 weight percent, at least 70 weight percent, at least 80 weight percent, at least 90 weight percent, at least 95 weight percent, at least 98 weight percent, or at least 99 weight percent of the monomeric units in the glassy block is derived from styrene.

The glassy blocks can represent from 5 to 50 percent by weight of the styrenic block copolymer. If the fraction of glassy blocks is too low, the cohesive strength may be too low. On the other hand, if the fraction of glassy blocks is too high, the modulus may be too high (i.e., the composition may be too stiff and/or too elastic) and the resulting composition will not effectively wet out on a substrate surface. The styrenic copolymer can have a styrene (or glassy block) content of from 7% to 40%, 9% to 33%, 13% to 25%, or in some embodiments, less than, equal to, or greater than 7%, 8, 9, 10, 11, 12, 13, 14, 15, 16, 17, 18, 19, 20, 21, 22, 23, 24, 25, 27, 30, 32, 35, 37, or 40%, relative to the overall weight of the styrenic block copolymer.

In addition to the glassy blocks and the rubbery blocks, styrenic block copolymers that are star block copolymers include a multifunctional coupling agent. The coupling agent often has multiple carbon-carbon double bonds, carbon-carbon triple bonds, or other groups that can react with carbanions of the living polymer used to form the star block copolymers. The multifunctional coupling agents can be aliphatic, aromatic, heterocyclic, or a combination thereof. Examples include, but are not limited to, polyvinyl acetylene, diacetylene, di(meth)acrylates (e.g., ethylene dimethacrylate), divinyl benzene, divinyl pyridine, and divinyl thiophene. Other examples include, but are not limited to, multi-functional silyl halide (e.g., tetrafunctional silyl halide), polyepoxides, polyisocyanates, polyketones, polyanhydrides, polyalkenyls, and dicarboxylic acid esters.

The weight average molecular weight of a styrenic block copolymer is often no greater than 1,200,000 g/mol. If the weight average molecular weight is too high, the copolymer will be difficult to use in preparation of a pressure-sensitive adhesive composition as high concentrations of organic solvent would be needed for solution coating. If melt processed, the copolymer would be difficult to extrude due to its high melt viscosity and would be difficult to blend with other materials. By contrast, a molecular weight that is too low can result in a pressure-sensitive adhesive with a cohesive strength that is unacceptably low.

The weight average molecular weight of the styrenic block copolymer may be no greater than 1,000,000 g/mol, no greater than 900,000 g/mol, no greater than 800,000 g/mol, no greater than 600,000 g/mol, or no greater than 500,000 g/mol. The weight average molecular weight of the styrenic block copolymer is typically at least 75,000 g/mol, at least 100,000 g/mol, at least 200,000 g/mol, at least 300,000 g/mol, or at least 400,000 g/mol.

The weight average molecular weight of the styrenic block copolymer can be from 75,000 g/mol to 1,200,000 g/mol, from 100,000 to 1,000,000 g/mol, from 100,000 to 900,000 g/mol, from 100,000 to 500,000 g/mol, or in some embodiments, less than, equal to, or greater than 75,000 g/mol; 80,000; 85,000; 90,000; 95,000; 100,000; 110,000; 120,000; 130,000; 140,000; 150,000; 160,000; 170,000; 180,000; 190,000; 200,000; 220,000; 240,000; 250,000; 260,000; 280,000; 300,000; 350,000; 400,000; 450,000; 500,000; 600,000; 700,000; 750,000; 800,000; 900,000; 1,000,000; or 1,200,000 g/mol.

Some styrenic block copolymers have glassy blocks that are polystyrene and one or more rubbery blocks selected from polyisoprene, polybutadiene, poly(isoprene/butadiene), poly(ethylene/butylene), and poly(ethylene/propylene). Some even more particular styrenic block copolymers have glassy blocks that are polystyrene and one or more rubbery blocks selected from polyisoprene and polybutadiene. In some embodiments, the styrenic block copolymers have glassy blocks that are polystyrene and one or more rubbery blocks that are polyisoprene.

In some embodiments, the styrenic block copolymer is a first styrenic block copolymer, and the block copolymer components further includes a second styrenic block copolymer that is a diblock copolymer. The diblock copolymer generally has a single glassy block and a single rubbery block, and can be represented here by the chemical structure G-R.

Inclusion of a diblock copolymer can lower the melt viscosity of the pressure-sensitive adhesive and/or provide functionality akin to that obtained when adding a plasticizer. In some embodiments, the diblock copolymer can increase the tackiness and low temperature performance of the resulting pressure-sensitive adhesive composition. The diblock copolymer also can be used to adjust the flow of the pressure-sensitive adhesive. The amount of diblock can be selected to provide the desired flow characteristics without significantly impacting the cohesive strength of the pressure-sensitive adhesive.

The same glassy blocks and rubbery blocks described with respect to the first styrenic block copolymer (e.g., triblock and star block copolymers) are applicable when describing the second styrenic block copolymer (i.e., the diblock copolymer).

The styrene content in the diblock copolymer can be from 10% to 50%, from 10% to 40%, from 15% to 50%, from 15% to 40%, from 20% to 50%, from 20% to 40%, or in some embodiments, less than, equal to, or greater than 10%, 12, 15, 17, 20, 22, 25, 27, 30, 32, 35, 37, or 40% by weight relative to the overall weight of the diblock copolymer.

The weight average molecular weight of the diblock copolymer can be from 75,000 to 250,000 g/mol, from 100,000 to 250,000 g/mol, from 125,000 to 250,000 g/mol, from 125,000 to 200,000 g/mol, or in some embodiments, less than, equal to, or greater than 75,000 g/mol; 80,000; 85,000; 90,000; 95,000; 100,000; 110,000; 120,000; 130,000; 140,000; 150,000; 160,000; 170,000; 180,000; 190,000; 200,000; 220,000; 240,000; or 250,000 g/mol.

The styrenic block copolymer component can represent 1 to 30 weight percent of the diblock copolymer based on a total weight of the diblock copolymer. In some embodiments, the diblock copolymer is present in an amount of from 1% to 25%, from 3% to 15%, from 5% to 10%, or in some embodiments, less than, equal to, or greater than 1%, 2, 3, 4, 5, 7, 10, 12, 15, 17, 20, 22, or 25% by weight relative to the overall weight of the second styrenic block copolymer.

In some embodiments, the styrenic block copolymer component contains 70% to 100% by weight of a star block copolymer and/or linear block copolymer (e.g., linear triblock copolymer) and 0% to 30% by weight of a diblock copolymer, 70% to 99% by weight of a star block copolymer and/or linear block copolymer and 1% to 30% by weight of a diblock copolymer, 70% to 90% by weight of a star block copolymer and/or linear block copolymer and 10% to 30% by weight of a diblock copolymer, 75% to 100% by weight of a star block copolymer and/or linear block copolymer and 0% to 25% by weight of a diblock copolymer, 75% to 99% by weight of a star block copolymer and/or linear block copolymer and 1% to 25% by weight of a diblock copolymer, 75% to 90% by weight of a star block copolymer and/or linear block copolymer and 10% to 25% by weight of a diblock copolymer, 80% to 100% by weight of a star block copolymer and/or linear block copolymer and 0% to 20% by weight of a diblock copolymer, 80% to 99% by weight of a star block copolymer and/or linear block copolymer and 1% to 20% by weight of a diblock copolymer, or 80% to 90% by weight of a star block copolymer and/or linear block copolymer and 10% to 20% by weight of a diblock copolymer.

In many embodiments, the styrenic block copolymer component contains 70% to 100% by weight of a linear triblock copolymer and 0% to 30% percent by weight of a diblock copolymer, 70% to 99% by weight of a linear triblock copolymer and 1% to 30% by weight of a diblock copolymer, 70% to 95% by weight of a linear triblock copolymer and 5% to 30% by weight of a diblock copolymer, or 70% to 90% by weight of a triblock copolymer and 10% to 30% by weight of a diblock copolymer.

The block copolymer component can be present in any suitable amount in the adhesive composition. For example, the block copolymer component may be present in amount of from 40% to 60%, from 45% to 55%, or in some embodiments, less than, equal to, or greater than 40%, 41, 42, 43, 44, 45, 46, 47, 48, 49, 50, 51, 52, 53, 54, 55, 56, 57, 58, 59, or 60% by weight relative to the overall weight of the composition.

Suitable materials for use as the styrenic block copolymer component alone or in combination are commercially available under the trade designation KRATON (e.g., KRATON D1161P, D1118, D1119, A1535) from Kraton Performance Polymers (Houston, TX, USA), under the trade designation SOLPRENE (e.g., SOLPRENE S-1205) from Dynasol (Houston, TX, USA), under the trade designation QUINTAC from Zeon Chemicals (Louisville, KY, USA), under the trade designation GLOBALPRENE from LCY Group (Taipei, Taiwan), and under the trade designations VECTOR and TAIPOL from TSRC Corporation (New Orleans, LA, USA).

The pressure-sensitive adhesive can contain from 40% to 60% by weight of the styrenic block copolymer component based on the total weight of the pressure-sensitive adhesive. If the amount of the styrenic block copolymer component is too low, the tackifier level may be too high and the resulting T_{g} of the composition may be too high (e.g., the composition may not be a pressure-sensitive adhesive), particularly in the absence of a plasticizer. If the amount of the styrenic block copolymer component is too high, the composition may have a modulus that is too high (e.g., the composition may be too stiff and/or too elastic) and the composition may not properly wet out when applied to a substrate.

The amount of the styrenic block copolymer component can be from 40% to 60%, 40% to 55%, 40% to 50%, 45% to 60%, 45% to 55%, 50% to 60%, or in some embodiments, less than, equal to, or greater than 40%, 41, 42, 43, 44, 45, 46, 47, 48, 49, 50, 51, 52, 53, 54, 55, 56, 57, 58, 59, or 60% by weight relative to the total weight of the pressure-sensitive adhesive.

### Tackifying Resin

Tackifying resins useful in embodiments of the present disclosure are known in the art. The provided adhesive compositions contain a first tackifying resin compatible with the rubbery midblock segment of the styrenic block copolymer and comprising a hydrocarbon.

The first tackifier is compatible with the rubbery block of the styrenic block copolymer and can be an aliphatic hydrocarbon tackifier, a terpene tackifier, a terpene phenolic tackifier, or a mixture thereof. The hydrocarbon tackifier is preferably compatible with the rubbery block but not with the glassy blocks of the block copolymer component. When incorporated into the adhesive composition in suitable quantities, the addition of the hydrocarbon tackifier can improve adhesion of the adhesive composition to low surface energy substrates.

The compatibility of the tackifier with the rubbery block can be determined by measuring the effect of the tackifier on the glass transition temperature of the rubbery block. If a tackifier is compatible, it will generally increase the glass transition temperature of the rubber block. Tackifiers such as hydrocarbon tackifiers, terpene tackifiers, and terpene phenolic tackifiers tend to be especially compatible with the rubbery block.

Useful hydrocarbon tackifiers include aliphatic hydrocarbon resins. In some embodiments, the aliphatic hydrocarbons are fully hydrogenated. Examples of hydrocarbon tackifiers include, but are not limited to, those commercially available under the trade designation ARKON (e.g., ARKON P140 and ARKON P125) from Arakawa Europe GmbH in Eschborn, Germany, under the trade designation REGALREZ (e.g., REGALREZ 1126) from Eastman Chemical Co. in Kingsport, TN, REGALITE (e.g., REGALITE 1125) from Eastman Chemical Co., under the trade designation ESCOREZ (e.g., ESCOREZ 5615, 5320, 1315, 1304, 5637, and 5340) from ExxonMobil Chemical Company in Spring, TX, under the trade designation OPPERA (e.g., OPPERA PR 100A) from Exxon, under the trade designation NEVTAC (e.g., NEVTAC 115) from Neville Chemical Company in Pittsburgh, PA, under the trade designation H-REZ (e.g., H-REZ C9 125H) from NUROZ LLC, in Miami, FL, under the trade designation ALPHATAC (e.g., ALPHATACK 115) from R.E. Carroll, Inc. in Ewing, NJ, under the trade designation RESINALL (e.g., RESINALL 1030 and 1030A) from Resinall Corporation in Severn, NC, and under the trade designation FUCLEAR (e.g., FUCLEAR FP-125 and FP-100) from United Performance Materials Corporation in Taipei, Taiwan.

Other suitable hydrocarbon tackifiers include terpenes. Terpenes include polyterpenes (e.g., alpha pinene-based resins, beta pinene-based resins, and limonene-based resins). Examples of terpenes include those available under the trade designation CLEARON (e.g., CLEARON P150 and P135) from Yasuhara Chemical Company, Ltd. in Hiroshima, Japan.

Still other suitable first tackifiers include terpene phenolic resins, also referred to as terpene phenolic tackifiers, or terpene phenolics. Example terpene phenolics include, but are not limited to, those available under the trade designation YS POLYSTER (e.g., POLYSTER T115, T160, T130, S145, and G150) from Yasuhara Chemical Company, Ltd. In Hiroshima, Japan.

The hydrocarbon tackifier can have a softening point from 80° C. to 160° C., from 100° C. to 150° C., from 115° C. to 145° C., or in some embodiments, less than, equal to, or greater than 80° C., 85, 90, 95, 100, 105, 110, 115, 120, 125, 130, 135, 140, 145, 150, 155, or 160° C. In some embodiments, the hydrocarbon tackifier is an aliphatic polymer to provide the desired compatibility with the rubbery block and to minimize compatibility with the glassy blocks.

The amount of the first tackifier present in the adhesive composition can be from 30% to 60%, from 30% to 55%, from 35% to 60%, or in some embodiments, less than, equal to, or greater than 30%, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60% by weight relative to the overall weight of the adhesive composition. If the amount of first tackifier is too high, the glass transition temperature of the resulting composition may be so high that it would not function as a pressure-sensitive adhesive. If the amount of first tackifier is too low, however, the modulus may be too high and the composition may not wet out well on substrate surfaces.

### Polyphenylene Oxide (“PPO”) Tackifier

The provided adhesive compositions further include at least a second tackifier that is compatible with the glassy end block segment and comprises a polyphenylene oxide (also referred to herein as a “polyphenylene ether”) tackifier. In some embodiments, the phenyl ether polymer contains the repeating unit shown in Structure II:

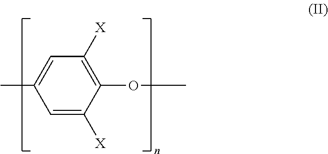

where each X is independently a monovalent substituent selected from the group consisting of hydrogen, halogen, hydrocarbon radicals, halohydrogen radicals having at least two carbon atoms between the halogen atom and the phenyl nucleus, hydrocarbonoxy radicals, and halohydrocarbonoxy radicals having at least two carbon atoms between the halogen atoms and phenyl nucleus. In some embodiments, each X is a methyl group.

By increasing the glass transition temperature of the glassy blocks of the block copolymer component, inclusion of the polyphenylene oxide tackifier can significantly increase the service temperature of the adhesive. The polyphenylene ether resins have a T_{g} and molecular weight within ranges that allow the resin to be compatible with the glassy block copolymer component. Suitable polyphenylene ether resins are commercially available under the trade designation NORYL (e.g., NORYL SA90 and SA120), from SABIC Americas, Houston, TX, United States.

The polyphenylene ether resin can provide the tackifier with a softening point of from 100° C. to 230° C., from 120° C. to 220° C., from 135° C. to 175° C., or in some embodiments, less than, equal to, or greater than 100° C., 105, 110, 115, 120, 125, 130, 135, 140, 145, 150, 155, 160, 165, 170, 175, 180, 185, 190, 195, 200, 205, 210, 215, 220, 225, and 230° C.

Polyphenylene ether resins can have a weight average molecular weight (Mw) of from 1,000 to 50,000 g/mol, 1,000 to 45,000 g/mol, 1,000 to 40,000 g/mol, 1,000 to 35,000 g/mol, 1,000 to 30,000 g/mol, 1,000 to 25,000 g/mol, from 2,000 to 10,000 g/mol, from 4,000 to 8,000 g/mol, or in some embodiments, less than, equal to, or greater than 1,000 g/mol; 1,200; 1,500, 1,700; 2,000; 2,500; 3,000; 3,500; 4,000; 4,500; 5,000; 5,500; 6,000; 6,500; 7,000; 7,500; 8,000, 8,500; 9,000; 9,500; 10,000; 11,000; 12,000; 13,000; 14,000; 15,000; 16,000; 17,000; 18,000; 19,000; 20,000; 21,000; 22,000; 23,000; 24,000; 25,000; 30,000; 35,000; 40,000; 45,000; or 50,000 g/mol. If the molecular weight of the polyphenylene ether resin is too low then the Tg will not be high enough, and it may become soluble in the mid block domain. If the molecular weight of the polyphenylene ether resin is too high, it may cause processing challenges in melting and making the PPO miscible with the styrenic component.

The second tackifier may be comprised partly or entirely of one or more polyphenylene ether resins. The amount of the second tackifier present in the adhesive composition is generally smaller than the amount of the first tackifier and can be from 1% to 15%, from 2% to 12%, from 4% to 8%, or in some embodiments, less than, equal to, or greater than 1%, 1.5, 2, 2.5, 3, 3.5, 4, 4.5, 5, 5.5, 6, 6.5, 7, 7.5, 8, 9, 10, 11, 12, 13, 14, or 15% by weight relative to the overall weight of the adhesive composition.

Polyphenylene ether resins can be made by known methods. Suitable methods of preparation are described in U.S. Pat. No. 3,306,874 (Hay); U.S. Pat. No. 3,306,875 (Hay); U.S. Pat. No. 3,257,357 (Stamatoff); and U.S. Pat. No. 3,257,358 (Stamatoff).

### Stabilizer

Stabilizers useful in embodiments of the present disclosure are known in the art and may be represented by Structure III:

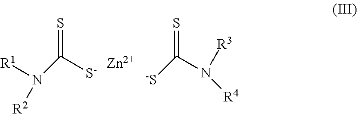

where each of R¹, R², R³, and R⁴ is independently selected from the group consisting of a C1 to C5 alkyl group, an unsubstituted phenyl group, a substituted phenyl group, an unsubstituted benzyl group, a substituted benzyl group, and combinations thereof. In some preferred embodiments each of R¹, R², R³, and R⁴ is an n-butyl group. Such stabilizers are available commercially, for example, under the trade designation VANLUBE EZ, available from R.T. Vanderbilt Holding Company, Norwalk, CT, United States.

The amount of the stabilizer present in the adhesive composition can be from 0.5% to 5% or in some embodiments, less than, equal to, or greater than 0.5%, 1%, 1.5%, 2%, 2.5%, 3%, 3.5%, 4%, 4.5%, or 5% by weight relative to the overall weight of the adhesive composition.

### Optional Additives

Adhesive compositions of the present disclosure may optionally comprise one or more additives such as, for example, tackifiers, plasticizers (e.g., polymers that are liquids at 25° C., a mineral oil, a polybutadiene homopolymer), antioxidants (e.g., hindered phenol compounds, phosphoric esters, or derivatives thereof), ultraviolet light absorbers (e.g., benzotriazole, oxazolic acid amide, benzophenone, or derivatives thereof), in-process stabilizers, anti-corrosives, passivation agents, light stabilizers, processing assistants, elastomeric polymers (e.g., other block copolymers), fillers (e.g., scavenger fillers, nanoscale fillers, transparent fillers), desiccants, crosslinkers, pigments, organic solvents, and combinations thereof. In some preferred embodiments, the adhesive composition may include an additive selected from the group consisting of a filler, a polyolefin film forming resin, a pigment, a second tackifying resin, a UV stabilizer, a foaming agent, a toughening agent, a thermal stabilizer, a secondary antioxidant, and combinations thereof. The total concentration of such additives ranges from 0 to 60 wt. % of the total adhesive composition.

In some embodiments, the adhesive composition may be a foamed composition. The foamed adhesive can be prepared by mixing into the adhesive composition a physical blowing agent, a chemical blowing agent, a low-density filler, or combinations thereof. Useful low-density fillers include, for example, hollow glass microspheres. Foamed adhesive compositions not only reduce weight but can be advantageous in applications where it is necessary for the adhesive to conform to surfaces that are rough or irregularly shaped.

### Adhesive Assemblies

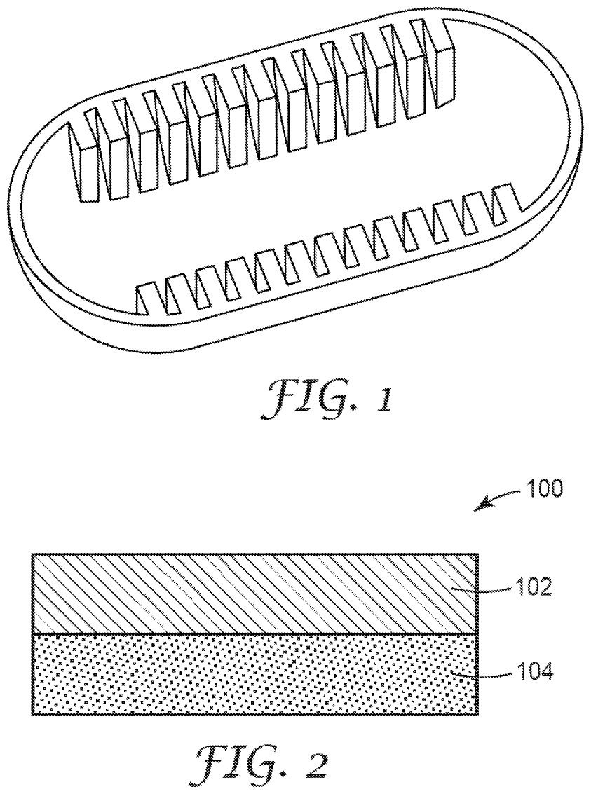

Adhesives of the present disclosure may be prepared by methods known to those of ordinary skill in the relevant arts. The ability to process these pressure-sensitive adhesives from the melt make them highly useful for bonding to molded articles made from polyolefins, and especially those having extreme surface features, such as the ribbed molded part shown in FIG. 1. A melt-processible adhesive can be 14 heated to flow into the interstices within such a ribbed structure and then cooled to afford a high bond strength not otherwise achievable using a conventional, flat adhesive sheet, for example, in a system including a core-sheath filament and a core-sheath filament dispenser, such as those described, for example, in WO 2019/164678 (Nyaribo et al.) and WO 2021/12481 (Napierala et al.).

An adhesive-backed tape 100 in one exemplary embodiment is illustrated in FIG. 2. The adhesive-backed tape 100 includes a backing 102 and a pressure-sensitive adhesive 104 made from the provided adhesive composition. As shown, the pressure-sensitive adhesive 104 is present as a layer extending across and directly contacting the backing 102. Advantageously, no primer layer is needed or present between the backing 102 and the pressure-sensitive adhesive 104.

The backing 102 can be made from any known material suitable for use as tape backings. Materials suitable for the backing 102 include polymeric foams and solid films made from polyolefins, such as polyethylene, including high density polyethylene, low density polyethylene, linear low density polyethylene, and linear ultra-low density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; polyurethanes; and combinations thereof. If the backing 102 is a foam, it can be either an open-cell or closed-cell foam. Further, the backing 102 may be made from an adhesive or non-adhesive material.

FIG. 3 shows a double-sided tape 200 that includes a first pressure-sensitive adhesive 204a disposed on a side of a backing 202 opposite that of a second pressure-sensitive adhesive 204b. Such a dual-sided construction may be appropriately used, for example, when bonding two different substrates to each other. The second pressure-sensitive adhesive 204b may be made from the same adhesive or a different adhesive from the first pressure-sensitive adhesive 204a.

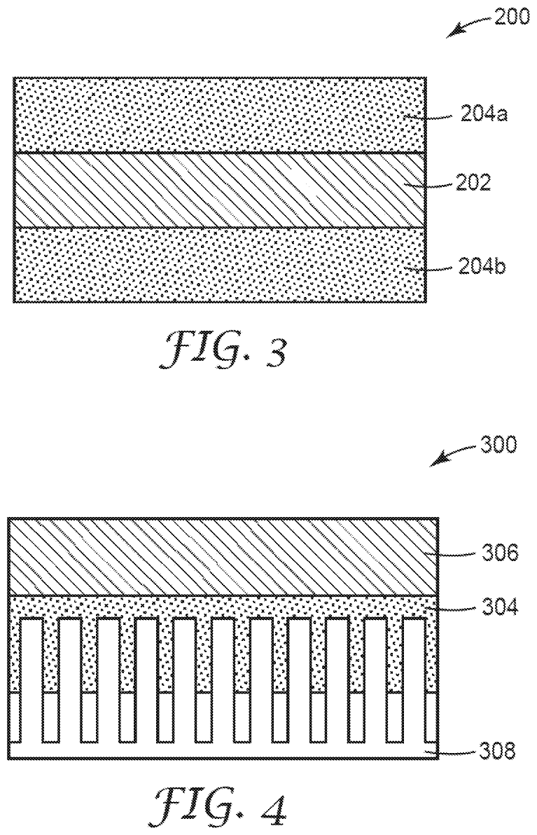

The provided adhesive compositions are melt processible, enabling their use in bonding to substrates with non-planar surfaces. This application is exemplified by the bonded assembly 300 illustrated in FIG. 4. The bonded assembly 300 shows a pressure-sensitive adhesive 304 interposed between a first substrate 306 and a second substrate 308, where the second substrate 308 is the molded part having a plurality of protruding ribs, as depicted in FIG. 1.

As shown, the pressure-sensitive adhesive 304 partially fills the cavities between the ribs of the second substrate 308, thereby allowing for a greater bond surface area and improved overall bond strength. This can be achieved by disposing the adhesive composition onto the second substrate 308 in molten form, allowing the melt to penetrate into the ribbed structure, and then cooling the adhesive composition to induce microphase separation of the adhesive composition and obtain the pressure-sensitive adhesive 304. The pressure-sensitive adhesive 304 can then be adhered to the first substrate 306. Optionally, the cavities of the second substrate 308 can be fully filled with the pressure-sensitive adhesive 304.

The sequence of steps above can be different from what is described above. For example, the adhesive composition may be disposed between the first and second substrates 306, 308 in molten form, the first and second substrates 306, 308 pressed together, and the adhesive composition cooled to form the bonded assembly 300 directly. Alternatively, the adhesive composition may be disposed between the second substrate 308 and a disposable release liner (not shown), the second substrate 308 and release liner pressed together, and then the adhesive composition cooled to form the pressure-sensitive adhesive 304. Later, the pressure-sensitive adhesive 304 can be peeled away from the release liner and adhered to the first substrate 306 to form the bonded assembly 300.

In some embodiments, the adhesive composition has a topologically-structured surface. The topologically-structured surface can be used to provide, for example, a layer of adhesive composition that varies in thickness depending on its location on the substrate. A topologically-structured surface can include an array of protrusions or depressions disposed on a surface that is otherwise planar. The protruding or depressed regions may be continuous or discrete in nature. The protrusions or depressions can be randomized across the topologically-structured surface or disposed according to a pre-determined replicated pattern with features regularly spaced from each other. Patterns of this type include rectilinear and hexagonal patterns.

The adhesive composition can be provided with a topologically-structured surface by disposing the adhesive composition from the polymer melt onto a topologically structured release surface and then cooling the composition to emboss the adhesive with a topologically-structured surface. Advantageously, such an adhesive can be a pressure-sensitive adhesive that can be transported and/or stored in this configuration. The pressure-sensitive adhesive can be later peeled away from the release surface prior to use.

The method above is merely exemplary, and other methods of smoothing or shaping the adhesive composition may be used by placing the adhesive composition in contact with a suitably shaped tool. If desired, the adhesive composition could be smoothed, embossed, or otherwise shaped after it has been disposed on a release surface or substrate, after it has microphase separated, or both.

In the aforementioned embodiments, the adhesive composition is applied onto the substrate as hot melt PSA using an automated method. Automated methods include, for example, use of a robotic arm to coat a PSA melt onto the substrate in a continuous or discontinuous manner.

Applications for the coated adhesive compositions are diverse and can include, for example, bonding solutions for corrugated materials, flooring, laminates, foams, porous fabrics, packaging materials, bookbinding, disposable products such as diapers and hygiene products, appliances, case and carton sealing, shoe manufacturing, electrical wires, wire bundles, and wire harnesses.

Either or both of the first and second substrates 206, 208 can be made from a low surface energy material, such as, for example, a thermoplastic polyolefin. Suitable substrates can be provided in any suitable size or shape. In one useful application the substrate is a clear coat layer, such as low surface energy clear coat layer, as might be provided on an aerospace or automotive exterior surface.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, materials used in the examples were obtained from commercial suppliers (e.g., Aldrich Chemical Co., Milwaukee, Wisconsin) and/or made by known methods. Materials prepared in the examples were analyzed by NMR spectroscopy and were consistent with the given structures. As used below, “hr”=hour.

### Materials Used in the Examples

| | |
|---|---|
| D1161 | A styrene-isoprene-styrene triblock copolymer having an approximate |
| | styrene content of 15% and 19% diblock content, available under the |
| | trade designation KRATON D1161 P from Kraton Performance |
| | Polymers, Houston, TX. |
| P140 | A fully hydrogenated hydrocarbon resin with a softening point of 140° C., |
| | available under the trade designation ARKON P140 from Arakawa, |
| | Osaka, Japan. |
| MIN OIL | Heavy mineral oil, available under the trade designation SUNMARK |
| | MINERAL OIL USP, from Mckesson Corporation, Irving, CA, United |
| | States. |
| LBR-361 | Polybutadiene homopolymer available under the designation LBR-361 |
| | from Kuraray, Houston, TX, United States |
| SA90 | Dual hydroxyl-end functional polyphenylene ether oligomer available |
| | under the trade designation NORYL SA90, from SABIC Americas, |
| | Houston, TX, United States |
| VAN EZ | Concentrated zinc diamyldithiocarbamate, a multifunctional additive |
| | available under the trade designation VANLUBE EZ, available from R.T. |
| | Vanderbilt Holding Company, Norwalk, CT, United States |
| IRG 1010 | Pentaerythritol tetrakis(3-(3,5-ditertbutyl-4-hydroxyphenyl)propionate), |
| | an antioxidant available under the trade designation IRGANOX 1010, |
| | available from BASF Corporation, Florham Park, NJ, United States |
| IRG 565 | 2,6-di-tert-butyl-4-(4,6-bis(octylthio)-1,3,5-triazin-2-ylamino) phenol, an |
| | antioxidant available under the trade designation IRGANOX 565, |
| | available from BASF Corporation, Florham Park, NJ, United States |
| VAN 81 | p,p′-dioctyldiphenylamine, an oxidation inhibitor available under the |
| | trade designation VANLUBE 81, available from R.T. Vanderbilt Holding |
| | Company, Norwalk, CT, United States |
| TMQ | Polymerized 1,2-dihydro-2,2,4-trimethylquinoline, an antioxidant |
| | available under the trade designation VANLUBE RD, available from |
| | R.T. Vanderbilt Holding Company, Norwalk, CT, United States |
| TEO | A high melt flow, mineral-filled thermoplastic elastomeric olefin (TEO) |
| | resin, available under the trade designation LYONDELL BASELL |
| | HIFAX TRC 779X from Standard Plaque Incorporated, Melvindale, MI, |
| | United States |
| LOPAREX 7350/7300 | Dual-sided silicone-coated 2mil PET film release liner, obtained under |
| | the trade designation LOPAREX 7350/7300 from Loparex, Hammond, |
| | WI, United States |
| AKRO BZX | Zinc dibutyldithiocarbamate, obtained under the trade designation |
| | AKROCHEM ACCELERATOR B.Z.X. from Akrochem Corporation, |
| | Akron, OH, United States |
| IRG 168 | Tris(2,4-di-tert-butylphenyl)phosphite, obtained under the trade |
| | designation IRGAFOS 168, available from BASF Corporation, Florham |
| | Park, NJ, United States |
| AKRO ZIX | Zinc isopropylxanthane, obtained under the trade designation |
| | AKROCHEM ACCELERATOR Z.I.X. from Akrochem Corporation, |
| | Akron, OH, United States |
| VANOX MTI | 2-mercaptotoluimidazole, obtained under the trade designation VANOX |
| | MTI GR, available from R.T. Vanderbilt Holding Company, Norwalk, |
| | CT, United States |

### Test Methods

### Rheological Storage Modulus Test Method:

The samples were analyzed using a DHR-3 parallel plate rheometer equipped with a Peltier plate accessory (TA Instruments, New Castle, DE, USA) to characterize the rheological properties of each sample as a function of frequency. Rheology samples were formed into an adhesive film approximately 1 mm thick between two LOPAREX 7350/7300 liners and subjected to different aging conditions, i.e., either closed-faced between two liners or open-faced on a single release liner. After aging, samples were punched out with an 8 mm circular die, removed from the release liners, centered onto the 8 mm diameter parallel plate upper fixture of the rheometer, and compressed down to the Peltier plate until the edges of the sample were uniform with the edges of the top plate.

Samples were conditioned at the test start temperature of 100° C. under an axial force control of 150 g with a sensitivity of +/−20 g for 180 seconds. A fixed strain of 5% was then applied and samples were tested from 10 to 0.1 Hz with five points per decade. While many physical parameters of the material are recorded during the frequency test, storage modulus (“G”) at 1 Hz is of primary importance in the characterization of the polymer blends of this disclosure. Rheology storage modulus values of 30 kPa or higher are preferred.

### Accelerated Aging Test Method:

The samples were formed into adhesive films approximately 1 mm thick on a LOPAREX 7350/7300 liner and subjected to different aging conditions (e.g., times, temperatures, closed- or open-faced) in a forced air oven (Blue M, New Columbia, Pennsylvania). A particularly preferred aging condition was 105° C. for 72 hours as it provided clear performance differentiation between the different antioxidant packages.

### Overlap Shear Test Method:

PSA test samples measuring 2.54 cm×1.27 cm pieces, were cut and the first LOPAREX 7350/7300 liner was removed. Next, an aluminum coupon was laminated to the exposed adhesive surface using 2 passes of a 6.8 kg steel roller in each direction. The second LOPAREX 7350/7300 liner on the adhesive was then removed. The exposed PSA surface was laminated to a TEO test panel (named as LYONDELL BASELL HIFAX TRC 779X), and rolled down using 2 passes of a 6.8 kg steel roller in each direction. The bonded samples were subjected to aging conditions at 105° C. as specified in Table 3. The overlap shear test was carried out using a tensile tester equipped with a 50 kiloNewton load cell at room temperature with a separation rate of 50 millimeters/minute. The average maximum force at break was recorded and used to calculate the average overlap shear strength in MegaPascals (MPa). Overlap shear strength values of 0.6 MPa or more are desirable.

### Stretch Release Test Method:

PSA test samples (either new or after aging) were cut to 12.5 mm wide and a minimum of 6 cm long. The first LOPAREX 7350/7300 liner was removed, and the exposed surface of the PSA test sample was laminated to a 15.2 cm×10.2 cm by 1.3 mm thick anodize aluminum test panel (Hiawatha Metalcraft, Inc., Minneapolis, MN, USA) such that at least 5 cm of adhesive was bonded to the panel with a 2.2 kg rubber roller with 4 passes. The long axis sample was oriented along the short axis of the aluminum panel, and the PSA test sample was oriented to overhang the aluminum panel edge by 1 cm, thereby creating a tab. The second LOPAREX 7350/7300 liner was removed, and a 2.5 cm anodized aluminum foil piece was attached to the tab and folded over to cover both sides of the PSA test specimen.

The test panel was mounted into the lower grips of a 5900 series Instron (Instron, Norwood, MA, USA) load frame equipped with a 1 kg load cell. The panel was oriented such that the longitudinal sample axis was vertical, and the sample tab was centered and tightened in the top grips. The resulting stretch release test was conducted along an approximately 0 degree angle between the panel and tab. The upper fixture moved at 100 cm per minute until the sample was completely debonded or cohesive failure occurred. Achieving at least 5 cm of stretch release from the aluminum panel before failure is considered a passing value. A maximum distance of 7.5 cm of stretch release was tested due to high sample elongation and the maximum travel distance of the Instron load frame.

### Gel Permeation Chromatography (“GPC”) Test Method:

The molecular weights of polymers referred to in this disclosure can be measured with gel permeation chromatography (“GPC”) using polystyrene calibration standards. GPC is an established methodology in which polymers are separated according to molecular size where the largest molecule elutes first. The elugraph is calibrated using commercially available polystyrene molecular weight standards (EASICAL, Agilent Technologies, Santa Clara, CA). The molecular weight of polymers measured using GPC so calibrated are styrene equivalent molecular weights. The molecular weights reported here will be polystyrene equivalent molecular weights from a GPC system utilizing tetrahydrofuran as the mobile phase and an Agilent 1260 HPLC system comprising two columns in a series, PLgel MIXED-B and MIXED-C, and a refractive index detector (Agilent Technologies, Santa Clara, CA).

When a polymer has a molecular weight distribution curve showing a single peak it is generally referred to as a unimodal polymer. A polymer having a curve showing two distinct peaks is generally referred to as bimodal polymer. A polymer having a curve showing three distinct peaks is generally referred to as trimodal polymer. Polymers having molecular weight distribution curves showing more than one peak may also collectively be referred to as multimodal polymers. For block copolymers, the different GPC modes are often attributable to specific polymer morphologies consisting of the primary block copolymer and specific fragments of the primary copolymer that are distinct fragments of the copolymer that are a result of chain termination at distinct steps in the resin making process.

The term “peak molecular weight” (“Mp”) is used herein. Mp refers to the styrene equivalent molecular weight of the highest peak as measured by GPC and is defined as the peak of the GPC plot for the defined region which could be the overall elugram or a specified mode of a multi-modal elugram prior to aging (i.e., 0 hr). The “dw/dlogMW” is the weight fraction of the sample having the corresponding styrene equivalent molecular weight (log M). The dw/dlogMW value at the Mp can be tracked for a given sample formulation to be used as a quantifiable but indirect approach to the relative amount of material remaining at that molecular weight. The dw/dlogMW value is reported at Mp in Table 3 as “GPC SIS Peak Height”.

### Preparation of Adhesive Examples:

The pressure-sensitive adhesive (“PSA”) samples were prepared using the compositions in Table 2. All amounts shown are given in parts by weight (“pbw”). The materials were compounded using a co-rotating 30 mm twin screw mixer (Krauss-Maffei Berstorff, Munich, Germany) and subjected to 200 rotations per minute (“rpm”) mixing for three minutes. The mixer and die temperatures were set to 170° C. After mixing, the PSA was melt pumped via gear pump and hose through a slot die, with approximate thickness of 1 millimeter. The PSA was cast onto the 7350, tight side (i.e., high release force side) of a LOPAREX 7350/7300 liner. The 7300, easy side (i.e., low release force side) of a second piece of a LOPAREX 7350/7300 liner was then laminated to the exposed adhesive surface of the transfer tape. The collected PSA was then evaluated according to the test methods above. The results are summarized in Table 3 below.

TABLE 2
PSA Formulations

| | | | MIN | LBR- | | VAN | IRG | IRG | VAN | | AKRO | IRG | AKRO | VANOX |
|---|---|---|---|---|---|---|---|---|---|---|---|---|---|---|
| Sample | D1161 | P140 | OIL | 361 | SA90 | EZ | 1010 | 565 | 81 | TMQ | BZX | 168 | ZIX | MTI |
| EX1 | 48 | 37 | 6 | — | 8 | 1 | — | — | — | — | — | — | — | — |
| EX2 | 47 | 37 | 6 | — | 8 | 2 | — | — | — | — | — | — | — | — |
| EX3 | 47 | 37 | 6 | — | 8 | 1 | — | — | — | 1 | — | — | — | — |
| EX4 | 47 | 37 | 6 | — | 8 | — | — | — | — | — | 1.5 | 0.5 | — | — |
| EX5 | 48 | 37 | 6 | — | 8 | — | — | — | — | — | 1 | — | — | — |
| EX6 | 47 | 37 | 6 | — | 8 | — | — | — | — | — | 2 | — | — | — |
| EX7 | 51 | 40 | — | — | 8 | 1 | — | — | — | — | — | — | — | — |
| EX8 | 48.5 | 37 | — | 6 | 8 | 0.5 | — | — | — | — | — | — | — | — |
| EX9 | 48 | 37 | — | 6 | 8 | 1 | — | — | — | — | — | — | — | — |
| EX10 | 47.5 | 37 | — | 6 | 8 | 1.5 | — | — | — | — | — | — | — | — |
| EX11 | 48.5 | 37 | — | 6 | 8 | — | — | — | — | — | 0.5 | — | — | — |
| EX12 | 48 | 37 | — | 6 | 8 | — | — | — | — | — | 1 | — | — | — |
| EX13 | 47.5 | 37 | — | 6 | 8 | — | — | — | — | — | 1.5 | — | — | — |
| EX14 | 47 | 37 | — | 6 | 8 | — | — | — | — | — | 2 | — | — | — |
| CE1 | 53 | 40 | 6 | — | — | 1 | — | — | — | — | — | — | — | — |
| CE2 | 48 | 37 | — | 6 | 8 | — | 1 | — | — | — | — | — | — | — |
| CE3 | 48 | 37 | — | 6 | 8 | — | — | 1 | — | — | — | — | — | — |
| CE4 | 48 | 37 | — | 6 | 8 | — | — | — | 1 | — | — | — | — | — |
| CE5 | 48 | 37 | — | 6 | 8 | — | — | — | — | 1 | — | — | — | — |
| CE6 | 47 | 37 | — | 6 | 8 | — | — | — | — | — | — | — | 2 | — |
| CE7 | 48 | 37 | — | 6 | 8 | — | — | — | — | — | — | 1 | — | — |
| CE8 | 48 | 37 | — | 6 | 8 | — | — | — | — | — | — | — | — | 1 |

TABLE 3
Test Results

| | Overlap Shear (MPa) | | | Rheology, G′ @ 100° C. (kPa) | | | | Stretch Release (mm) | | GPC SIS Peak Height | | |
|---|---|---|---|---|---|---|---|---|---|---|---|---|
| | Aged | Aged | Aged | No | Aged | Aged | Aged | | Aged 72 | No | Aged | Aged |
| Sample | 24 hr | 48 hr | 72 hr | Aging | 24 hr | 48 hr | 72 hr | Aged 24 hr | hr | Aging | 24 hr | 72 hr |
| EX1 | 1.1 | 1.5 | 0.7 | 88 | 68 | 46 | 29 | 64 | 75 | 1.08 | 0.79 | 0.47 |
| EX2 | 0.7 | 1.1 | 0.5 | 75 | 62 | 52 | 29 | 75 | 75 | 1.28 | 0.98 | 0.52 |
| EX3 | 0.6 | 0.9 | 0.6 | 89 | 88 | 56 | 38 | 75 | 75 | 1.12 | 0.94 | 0.55 |
| EX4 | 0.48 | 0.64 | 0.63 | 69 | 56 | 46 | 38 | 75 | 75 | 1.18 | 0.90 | 0.55 |
| EX5 | 0.53 | 0.65 | 0.71 | 84 | 52 | 51 | 39 | 60 | 75 | 1.27 | 0.91 | 0.55 |
| EX6 | 0.64 | 0.67 | 0.63 | 68 | 55 | 42 | 36 | 75 | 75 | 1.21 | 0.88 | 0.50 |
| EX7 | — | — | — | 98 | 70 | 58 | 48 | 56 | 75 | 1.26 | 0.51 | 0.34 |
| EX8 | — | — | — | 105 | 102 | 78 | 66 | 75 | 74 | 1.23 | 1.06 | 0.69 |
| EX9 | — | — | — | 101 | 86 | 69 | 63 | 75 | 75 | 1.29 | 1.03 | 0.69 |
| EX10 | — | — | — | 87 | 94 | 65 | 58 | 74 | 75 | 1.21 | 1.03 | 0.63 |
| EX11 | — | — | — | 101 | 100 | 75 | 43 | 75 | 75 | 1.23 | 1.03 | 0.63 |
| EX12 | — | — | — | 89 | 93 | 73 | 40 | 75 | 74 | 1.25 | 0.99 | 0.59 |
| EX13 | — | — | — | 94 | 91 | 61 | 40 | 75 | 75 | 1.19 | 1.02 | 0.48 |
| EX14 | — | — | — | 84 | 86 | 71 | 33 | 75 | 74 | 1.18 | 1.00 | 0.55 |
| CE1 | 0.9 | 0.8 | 1.1 | 51 | 55 | 49 | 41 | 75 | 75 | 1.33 | 1.32 | 1.20 |
| CE2 | 0.5 | 0.4 | 0.6 | 80 | 11 | 5 | 5 | 8 | 0 | 0.77 | 0.21 | 0.12 |
| CE3 | 0.5 | 0.4 | 0.4 | 84 | 4 | 0 | 0.1 | 0 | 0 | 0.86 | 0.21 | 0.13 |
| CE4 | 0.8 | 0.4 | 0.4 | 72 | 6 | 1 | 0.4 | 0 | 0 | 0.79 | 0.17 | 0.12 |
| CE5 | 1.4 | 0.9 | 0.7 | 88 | 5 | 1 | 0.1 | 0 | 0 | 0.85 | 0.22 | 0.13 |
| CE6 | 0.8 | 1.8 | 1 | 79 | 52 | 7 | 0.7 | 74 | 15 | 0.87 | 0.53 | 0.15 |
| CE7 | 1.0 | 0.5 | 0.7 | 75 | 5 | 18 | 37.8 | 13 | 0 | 0.79 | 0.18 | 0.22 |
| CE8 | 0.7 | 0.5 | 0.4 | 69 | 23 | 16 | 25.5 | 37 | 0 | 0.76 | 0.10 | 0.09 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A composition comprising:
40 wt. % to 60 wt. % of a block copolymer comprising polystyrene and polyisoprene;
30 wt. % to 60 wt. % of a first tackifying resin;
1 wt. % to 15 wt. % of a polyphenylene oxide tackifier; and
0.5 wt. % to 5 wt. % of a stabilizer represented by the structure 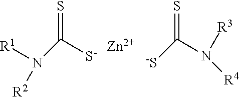
wherein each of R¹, R², R³, and R⁴ is independently selected from the group consisting of a C1 to C5 alkyl group, an unsubstituted phenyl group, a substituted phenyl group, an unsubstituted benzyl group, a substituted benzyl group, and combinations thereof.

2. The composition of claim 1, wherein the block copolymer comprises a polystyrene-polyisoprene-polystyrene copolymer selected from the group consisting of a polystyrene-polyisoprene-polystyrene triblock copolymer, a polystyrene-polyisoprene-polystyrene radial star block copolymer, and combinations thereof.

3. The composition of claim 1, wherein the first tackifying resin is selected from the group consisting of an aliphatic hydrocarbon tackifier, a terpene tackifier, a terpene phenolic tackifier, and combinations thereof.

4. The composition of claim 1 comprising 2 wt. % to 12 wt. %, optionally 4 wt. % to 8 wt. % of the polyphenylene oxide tackifier.

5. The composition of claim 1, wherein each of R¹, R², R³, and R⁴ is an n-butyl group.

6. The composition of claim 1, further comprising a plasticizer.

7. The composition of claim 6, wherein the plasticizer is selected from the group consisting of a mineral oil, a polybutadiene homopolymer, and combinations thereof.

8. The composition of claim 1, further comprising an additive selected from the group consisting of a filler, a polyolefin film forming resin, a pigment, a second tackifying resin, a UV stabilizer, a foaming agent, a toughening agent, a thermal stabilizer, a secondary antioxidant, and combinations thereof.

9. An adhesive comprising the composition of claim 1.

10. The adhesive composition of claim 9, wherein the adhesive comprises a pressure-sensitive adhesive.

11. The adhesive composition of claim 9, wherein the adhesive composition is hot-melt processible

12. The adhesive composition of claim 11, wherein G′ is greater than 25 kPa at 100° C. at 1 Hz as measured by the Rheological Storage Modulus Test.

13. The adhesive composition of claim 10, wherein the stretch release is greater than 50 mm at 23° C., 65% Humidity as measured by the Stretch Release Test.

14. The adhesive composition of claim 10, wherein the SIS triblock Peak Height after aging at 105° C. for 72 hours according to the Accelerated Aging Test is at least 40% of the SIS triblock Peak Height of the unaged sample as measured by the Gel Permeation Chromatography Test

15. An article comprising the adhesive of claim 9.

16. The article of claim 15, wherein the article is a tape.

17. The article of claim 15, wherein the article is a core-sheath filament.

18. A bonded assembly comprising the adhesive of claim 9.

19. A method of preparing a stabilized hot melt pressure-sensitive adhesive, the method comprising:
combining 40 wt. % to 60 wt. % of a block copolymer comprising polystyrene and polyisoprene, 30 wt. % to 60 wt. % of a first tackifying resin, 1 wt. % to 15 wt. % of a polyphenylene oxide tackifier, and 0.5 wt. % to 5 wt. % of a stabilizer represented by the structure 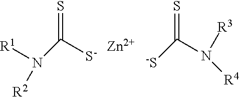
wherein each of R¹, R², R³, and R⁴ is independently selected from the group consisting of a C1 to C5 alkyl group, an unsubstituted phenyl group, a substituted phenyl group, an unsubstituted benzyl group, a substituted benzyl group, and combinations thereof.

20. The method of claim 19, wherein combining occurs in a twin-screw extruder at a temperature of greater than 160° C.
